(19) United States
(12) Patent Application Publication
(10) Pub. No.: US 2012/0023048 A1
(43) Pub. Date: Jan. 26, 2012

(54) MOTION DISCRIMINATION SYSTEM, METHOD FOR STRUCTURING MOTION DISCRIMINATION MODEL, METHOD FOR MOTION DISCRIMINATION AND COMPUTER PROGRAM FOR MOTION DISCRIMINATION

(76) Inventors: Tadashi Komatsu, Hokkaido (JP); Takuji Nagai, Hokkaido (JP); Takayuki Fukagawa, Hokkaido (JP); Suguru Horinouchi, Hokkaido (JP)

(21) Appl. No.: 12/998,230

(22) PCT Filed: Sep. 25, 2009
(86) PCT No.: PCT/JP2009/004889

§ 371 Date: Jul. 25, 2011

(30) Foreign Application Priority Data
Sep. 29, 2008 (JP) 2008-250072

(51) Int. Cl. G06N 3/02; G06F 15/18

(52) U.S. Cl. 706/14; 706/19

(57) ABSTRACT

Problem to be solved by the invention: The present invention aims at providing a motion discrimination system and a method for motion discrimination capable of real-time and accurate detecting motions of an object.

Means to solve the problem: A motion discrimination system according to the present invention comprises: a detecting means for outputting different analog values corresponding to motion of an object in each of a plurality of detecting areas; a data processing means for processing the analog values output corresponding to the motion in each of the plurality of detecting areas to quantized time-series data; and a motion discrimination means for outputting a motion discrimination result using a motion discrimination model in which the time-series data are inputs and types of motions are outputs. The motion discrimination model is a neural network in which the time-series data are inputs to input nodes and the types of motions are outputs from output nodes.

Selected drawing: FIG. 1

### TECHNICAL FIELD

The present invention relates to motion discrimination technique. More particularly, the present invention relates to motion discrimination system, method for motion discrimination and computer program for motion discrimination for accurately discriminating motion of an object by using an optimized detecting means for outputting different signals in response to motion of an object in detecting area and a motion discrimination model optimized by previous learning. The present invention also relates to method for structuring optimized motion discrimination model for use in said motion discrimination system.

### BACKGROUND ART

Today, progressive aging of society and deteriorating security constitute backgrounds for researching and developing various motion discrimination techniques which allows for discriminating events with temporal range such as motion of an object including a human. To analyze motion of an object including a human, researching and developing of so-called pattern-recognition (PR) technique for capturing motion of an object by any means to input information or signal generated based on the motion into a neural network for discriminating have been actively underway (for example, refer to the Patent Document 1 to the Patent Document 3).

On the other hand, increase of nuclear families and advance of aging society bring an increase of various facilities for housing and caring elderly persons. However, in such facilities, many residents have to be cared only by a few staffs, and it is difficult to constantly monitor motion and action of the residents by the few staffs. Thus, when a resident tries to act independently in a situation where a staff cannot monitor or tries to act at night, an accident such as falling from a bed or falling on ground may occur, and a staff may not even notice when an accident occurs. To avoid such accident, there is a way that an area of resident's action is forcibly restrained by using a locking device, but such way is accompanied with much distress for residents. Similar problem exists for elderly persons and patients who have difficulty for entering such facilities and to be cared at their home. To address the above, regardless whether at such facilities or at homes, there is a need for technique to constantly monitor motion of an object on behalf of facility staffs or family members, without delimiting an area of action of an object who may be a cared person, a patient or an elderly person (hereinafter referred as a patient etc.), to prevent any accident or to immediately report to facility staffs or an appropriate facility when an accident should occur.

As such technique, the inventions using pressure sensor, load detection sensor, weight detection sensor, piezoelectric sensor, and acceleration sensor have been disclosed in the Patent Document 4 to the Patent Document 6.

The Patent Document 4 discloses the invention wherein weight detection elements are provided on posts of a bed where cared person lies thereon for calculating activity patterns of the cared person from data, for example a combination of amount of activities, a number of activities and speed of activities, related to position of center of gravity of the cared person on the bed to determine that the person should be cared when the activity pattern is not a normal activity pattern.

The Patent Document 5 discloses the invention wherein a plurality of pressure sensors are arranged on a bed mattress and detected signals being output from the plurality of pressure sensors in response to motion of a cared person on the bed are used to notify a caregiver that the cared person is off from the bed.

The Patent Document 6 discloses the invention wherein a portable transmitter including an acceleration sensor is mounted on a patient for detecting acceleration working on the patient as well as pulse, electrocardiograph and blood pressure of the patient to detect falling on ground or falling from bed of the patient based on the signals from the transmitter to notify abnormalities to nurses.

Examples of other techniques include a method for capturing images of a patient etc. with a camera and monitoring the images in another room, and a method for processing the images of the patient captured with a camera to input to a neural network and discriminating motion of the patient by using an output from the neural network. For example, the Patent Document 7 discloses the invention wherein images of motion of an examinee on a bed are captured at a certain interval for converting to such as silhouette images to identify whether the examinee is awake or asleep by using the image data, and to determine whether or not the examinee will rise from the bed by using a neural network, for automatically notifying predetermined nurses when it is detected that the examinee rises from the bed.

The prior art documents referred to in the above descriptions are listed below.
Patent Document 1: Japanese Laid-Open Patent Publication JP5-282273A
Patent Document 2: Japanese Patent No. 3237048B
Patent Document 3: Japanese Patent No. 3627321B
Patent Document 4: Japanese Laid-Open Patent Publication JP2000-316915A
Patent Document 5: Japanese Laid-Open Patent Publication JP2000-271098A
Patent Document 6: Japanese Laid-Open Patent Publication JP2008-47097A
Patent Document 7: Japanese Laid-Open Patent Publication JP2007-72964A
Patent Document 8: Japanese Laid-Open Patent Publication JP2007-220055A

### DISCLOSURE OF THE INVENTION

### Problem to be Solved by the Invention

Aforementioned various conventional techniques for discriminating motion of an object such as a patient etc., however, have the following problems.

In conventional techniques that use sensors, such as pressure sensor, load detection sensor, weight detection sensor, piezoelectric sensor, and acceleration sensor, alone or in combination with other biological signal detection device, those sensors directly detect motion of an object. Thus, when only a few sensors are used, what can be obtained may be limited to so-called on-off information indicating, for example, whether or not a patient has left a bed and it is difficult to determine type of the motion as well as its direction and speed. Although it is required to use many sensors for accurately detecting type, direction and speed of motion of an object, it raises other problems such as increase of cost and complexity of a system. In addition, since the sensors in these techniques directly detect motion and action of an object, if the object moves outside of a detecting area, the motion may not be detected. In a conventional technique using an infrared active sensor, it is similarly required to provide many emitting parts and receiving parts of infrared beam for accurately detecting type, direction and speed of motion of a patient etc. in a certain area, which in turn increases cost and complexity of a system. A system using only a few sensors cannot cope with cases when a patient etc. moves outside of a detecting area.

A conventional technique using image or video capturing a patient etc. may be a complex and expensive system, while it may raise another problem of an individual privacy as it handles image or video. A system for remotely monitoring image or video captured by a camera requires a monitor to visually monitor the image or the video, and an appropriate judgment by the monitor is what makes the system effective in the first place. In a case where a specific motion of a patient etc. lasts for a long period of time, problematic motions may be discriminated by monitoring image or video, but to avoid overlooking a motion that occurs in a short period of time, it is considered that a time length similar to a monitoring time is required for discrimination. Securely capturing a motion that occurs in a short time compared to a whole monitoring time, such as an abnormal motion that occurs only once, may be mentally and physically heavy burden to the monitor.

A conventional technique for predicting a patient etc. rising from a bed by using a combination of an image captured with a camera and a neural network captures the patient with a camera and discriminates motion of the patient based on the captured image data. Therefore, in a case when a difference of color or contrast between the patient to be discriminated and a background is small, for example at night or when a difference between a color of the patient's cloths and a color of background such as a wall is minimal, an accuracy of motion discrimination may be deteriorated. In addition, accuracy for detecting type, direction and speed of motion of an object may possibly be higher than other techniques where sensors are used independently, but cost and privacy invasion may be feared to be problematic.

To address the above mentioned problems with conventional techniques, the inventors of the present application consider it is preferable to structure a motion discrimination system using passive sensors for accurate, inexpensive and privacy-considered detection of type, direction and speed of motion of a patient etc. in a certain area. The passive sensor is what can solve the various problems accompanying the above conventional techniques as it can detect a difference between an amount of heat emitted from an object and that from a background, and output a voltage waveform superposed with a feature value corresponding to a motion of the object. However, change of the voltage waveform generated by the passive sensor is complex and minute. Thus, it is extremely difficult to directly and clearly discriminate type of a motion from change of the voltage waveform output from the passive sensor and to structure a versatile motion discrimination system that is capable of discriminating motions in spite of individual differences using only information obtained with the passive sensor. To this end, the inventors of the present application have already proposed a method for pattern-recognition by inputting information obtained with a passive sensor into a neural network to extract features of a motion of an object (the Patent Document 8).

The technique disclosed in the Patent Document 8 is a basic principle for identifying a motion of an object by using a passive sensor and a neural network, but as a technique to be used for actually structuring a motion discrimination system, the technique substantially could not provide high discrimination accuracy. In other words, the Patent Document 8 discloses an invention of a basic technique for simply inputting data related with a motion of an object obtained from sensors into a neural network so that a result of discrimination can be output from the neural network, but does not disclose any technique for obtaining a necessary accuracy of discrimination for structuring a practical system usable in actual sites such as medical facilities and so forth. To enable structuring a practical system, both a passive sensor for capturing a motion of an object and a neural network for inputting an output data from the passive sensor to output discrimination result should be optimized. For example, when a passive sensor is not set at an optimum condition with respect to a motion of an object, then even if an output from the passive sensor is input into the neural network, it may not be possible to obtain an optimum discrimination result, since the obtained data corresponding to the motion of the object may not reflect features of the motion. Similarly, when a neural network is not set at an optimum condition with respect to a motion of an object, it may not be possible to obtain an optimum discrimination result.

Therefore, it is an object of the present invention to provide a motion discrimination system and a method for motion discrimination which allow for real-time and accurate detection of a motion of an object in a certain area with a passive sensor, which conditions thereof are optimized using a neural network and a motion discrimination model optimized using a neural network, and which can be inexpensively structured.

### Means for Solving the Problem

According to one aspect of the present invention, an optimized motion discrimination system for real-time motion discrimination of an object is provided. The motion discrimination system according to the present invention is characterized in that it comprises a detecting means for outputting different analog values corresponding to a motion of an object in each of a plurality of detecting areas, a data processing means for processing the analog values output corresponding to the motion in each of the plurality of detecting areas to quantized time-series data, and a motion discrimination means for discriminating the motion using a motion discrimination model in which the time-series data are inputs and a type of motion is output and outputting a motion discrimination result.

According to another aspect of the present invention, a method for a motion discrimination to discriminate a motion of an object in real-time is provided. The method for motion discrimination according to the present invention is characterized in that it comprises: a detecting step to obtain analog values corresponding to a motion of an object using the detecting means for outputting the different analog values corresponding to the motion of the object in each of the plurality of detecting areas; a data processing step to process the analog values output corresponding to the motion in each of the plurality of detecting areas to quantized time-series data; and a motion discriminating step to discriminate the motion using the motion discrimination model in which the time-series data are inputs and a type of motion is output and output a motion discrimination result.

As a motion discrimination model, it is preferable to use a neural network in which the time-series data are inputs to input nodes and the type of motion is output from output node.

It is preferable that the motion discrimination model is optimized by obtaining analog values corresponding to a known motion of an object using a detecting means, processing the output analog values corresponding to the known motion in each of a plurality of detecting areas to quantized time-series data, outputting a motion discrimination result corresponding to the known motion by inputting the time-series data into the input node of the neural network and outputting the type of motion from the output node, and adjusting parameters of the neural network based on a comparison between the motion discrimination result and the known motion.

As a detecting means, it is preferable to use one which comprises passive sensors with a plurality of detecting elements and a plurality of lenses, and it is preferable that the plurality of detecting elements are any of dual-elements or quad-elements or a combination thereof.

It is preferable that the detecting means is optimized by performing steps of: obtaining analog values corresponding to a known motion of an object using a detecting means; processing the analog values output corresponding to the known motion in each of a plurality of detecting areas to quantized time-series data; discriminating the known motion using a neural network in which the time-series data are inputs to the input nodes of the neural network and the type of motion is output from the output node and outputting a motion discrimination result corresponding to the known motion; and altering conditions of the detecting means based on the motion discrimination result.

The conditions of the detecting means may be one or more of a combination of type, a number, position, sensitivity and rotating angle of a plurality of detecting elements, types and rotating angle of a plurality of lenses mounted on each of the plurality of detecting elements, and a mounting angle of the detecting means.

It is preferable that the motion discrimination means further comprises a time-series analysis model that discriminates the motion based on a time-series relationship of a plurality of discrimination results discriminated by the motion discrimination model and outputs the results of the discrimination. The time-series relationship may be a ratio of a number of discrimination results discriminated as a certain motion to a number of other discrimination results discriminated as the other motion and a consecutive number of the discrimination results discriminated as a certain motion, the ratio and the consecutive number being calculated for a predetermined number of a plurality of sequentially output discrimination results.

It is preferable that the system further comprises a determining means for comparing the analog values output from the detecting means and a predetermined threshold value, which is configured such that motion discrimination is not performed when the analog values are smaller than the predetermined threshold value.

According to further aspect of the present invention, a method for structuring a motion discrimination model optimized for discriminating motion in a motion discrimination system which discriminates a motion of an object in real-time is provided. The method is characterized in that it comprises: a detecting step to obtain analog values corresponding to a known motion of an object using a detecting means for outputting different analog values corresponding to the motion of the object in each of a plurality of detecting areas; a data processing step to process the analog values output corresponding to the known motion in each of the plurality of detecting areas to quantized time-series data; a motion discriminating step to discriminate the known motion using a neural network in which the time-series data are inputs to the input nodes of a neural network and the type of motion is output from output node and output a motion discrimination result corresponding to the known motion; and a optimizing step to adjust parameters of the neural network based on a comparison between the motion discrimination result and the known motion.

According to yet further aspect of the present invention, a computer program comprising a program code instructions for making computer execute the steps of the method for motion discrimination and the method for structuring the motion discrimination model according to the present invention is provided.

According to the present invention, type of a motion of an object performing a certain motion may be discriminated in real-time by using voltage waveform data that are output from sensors and are different corresponding to types of motions and a motion discrimination model optimized such that the types of motions appearing on the voltage waveform can be discriminated from characteristics of the voltage waveforms corresponding to the motions. In the present invention, an imaging device such as a camera is not used as a means for capturing a motion of an object, so that privacy of the object is not feared to be invaded.

In the present invention, since a neural network that is optimized in advance through a parameter adjusting process using a known motion is used as a motion discrimination model, types of motions of an object may be accurately discriminated from different subtle characteristics reflected on the data output from the sensors.

In the present invention, accuracy of motion discrimination may be improved as passive sensors that convert a temperature difference (change in amount of infrared rays) between an object and its background to a voltage waveform for outputting are used as sensors for capturing motion of the object to allow for appropriate capturing of direction and speed of the motion of the object only with a few sensors, as well as a cost of a system may be reduced as only a few sensors are used. In addition, since the passive sensors are used to capture motions of an object with a difference in amount of infrared rays between the object and its background, accuracy of motion discrimination is not deteriorated even when a contrast difference between the object and its background is small or at night.

Since sensor conditions such as types of elements and types of lenses of the detecting means used in the present invention are optimized through an optimizing process of measuring a known motion, the voltage waveforms output from the detecting means appropriately shows characteristics that are different for types of motions. Accuracy of discriminating characteristics of motions in a neural network may be further improved by using such optimized detecting means.

In the present invention, results of discrimination output from a motion discrimination model are highly accurate because optimized sensors and an optimized motion discrimination model are used. However, in the present invention, further accurate discrimination results may be obtained by further using a time-series analysis model for analyzing a time-series relationship between a plurality of discrimination results output from the motion discrimination model, than independently using results output from the motion discrimination model.

### BRIEF DESCRIPTION OF THE DRAWINGS

FIG. 1 is a block diagram showing a basic configuration of a motion discrimination system according to an embodiment of the present invention.

FIG. 2 is a schematic flowchart showing a process for discriminating an unknown motion in real-time by an optimized motion discrimination system according to an embodiment of the present invention.

FIG. 3 is a view illustrating an optimized motion discrimination system mounted above a bed which a patient etc lying thereon.

FIG. 4 (a) is a schematic diagram illustrating an exterior of an optimized motion discrimination system according to an embodiment of the present invention.

FIG. 4 (b) is a schematic diagram illustrating a configuration of an optimized motion discrimination system according to an embodiment of the present invention.

FIG. 5 is a perspective view illustrating a detecting area of an optimized motion discrimination system according to an embodiment of the present invention.

FIG. 6 is a perspective view illustrating a detecting area of an optimized motion discrimination system according to an embodiment of the present invention.

FIG. 7 is a perspective view illustrating a detecting area of an optimized motion discrimination system according to an embodiment of the present invention.

FIG. 8 is a side view illustrating a detecting area of an optimized motion discrimination system according to an embodiment of the present invention.

FIG. 9 shows examples of voltage waveforms output by a sensor module part of an optimized motion discrimination system according to an embodiment of the present invention.

FIG. 10 (a) is a schematic flowchart illustrating processing of a voltage waveform according to an embodiment of the present invention.

FIG. 10 (b) is a schematic diagram illustrating data after processing according to an embodiment of the present invention.

FIG. 11 is a schematic flowchart illustrating a motion discrimination processing performed with an optimized motion discrimination model and a time-series analysis model according to an embodiment of the present invention.

FIG. 12 is a schematic diagram illustrating a multilayer neural network used as an optimized motion discrimination model in an embodiment of the present invention.

FIG. 13 is a flowchart illustrating in more detail the process in FIG. 11 by an optimized motion discrimination system according to an embodiment of the present invention.

FIG. 14 is a schematic flowchart illustrating a procedure for optimizing sensor conditions according to an embodiment of the present invention.

FIG. 15 is a schematic flowchart illustrating a procedure for optimizing a motion discrimination model according to an embodiment of the present invention.

FIG. 16 is a schematic flowchart illustrating a process for determining threshold conditions according to an embodiment of the present invention.

### BEST MODE FOR CARRYING OUT THE INVENTION

Embodiments of the present invention will be described in detail in the following with reference to the drawings for examples of a system and a method for discriminating motion of an object such as a cared person, a patient or an elderly person (patient etc.).

### 1. Outline of the Block Diagram of a Motion Discrimination System and of Each Block

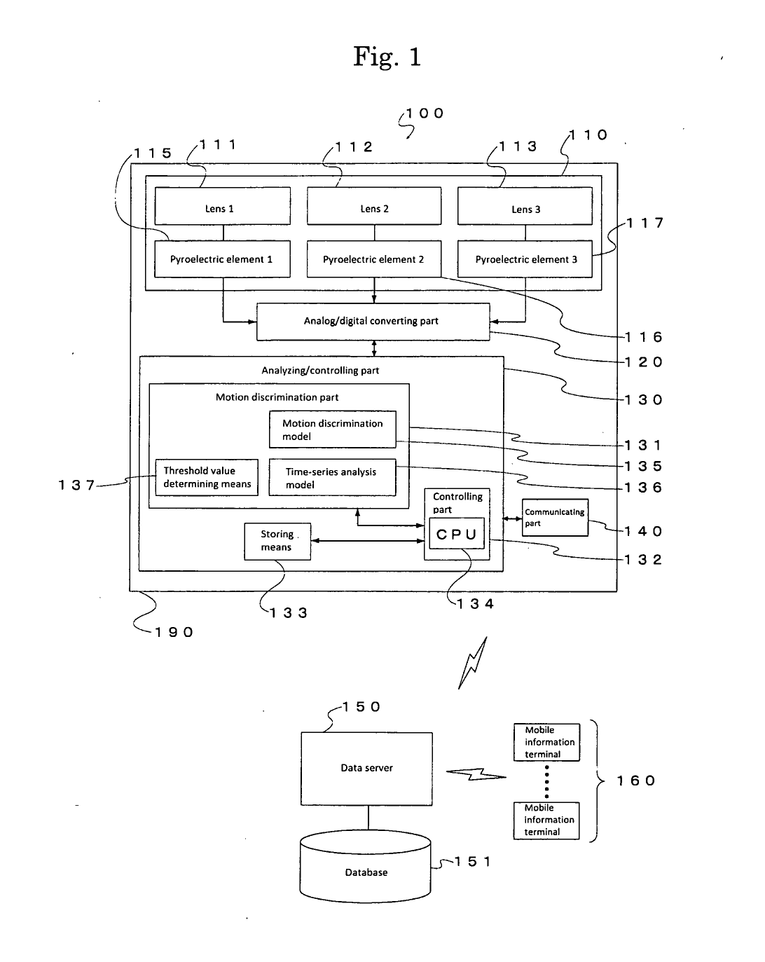

FIG. 1 is a block diagram showing a basic configuration of a motion discrimination system 100 according to an embodiment of the present invention. The motion discrimination system 100 comprises: a sensor module part 110 (a detecting means) including a pyroelectric element (a detecting element) and a lens mounted on or overlaid on the pyroelectric element; an analog/digital converting part 120 (a data processing means) for receiving consecutive voltage values i.e. voltage waveforms output from the sensor module part 110 to sample the received voltage waveforms at a predetermined rate as well as to process the received voltage waveforms into sampled data (quantized time-series data) for a predetermined time length; an analyzing/controlling part 130 including a motion discrimination part (a motion discrimination means) 131 for discriminating motion using the processed data and a controlling part 132 for controlling the entire system; a communicating part 140 for transmitting motion discrimination results to a data server 150; the data server 150 and a database 151; and a mobile information terminal 160 for receiving discrimination results from the data server 150.

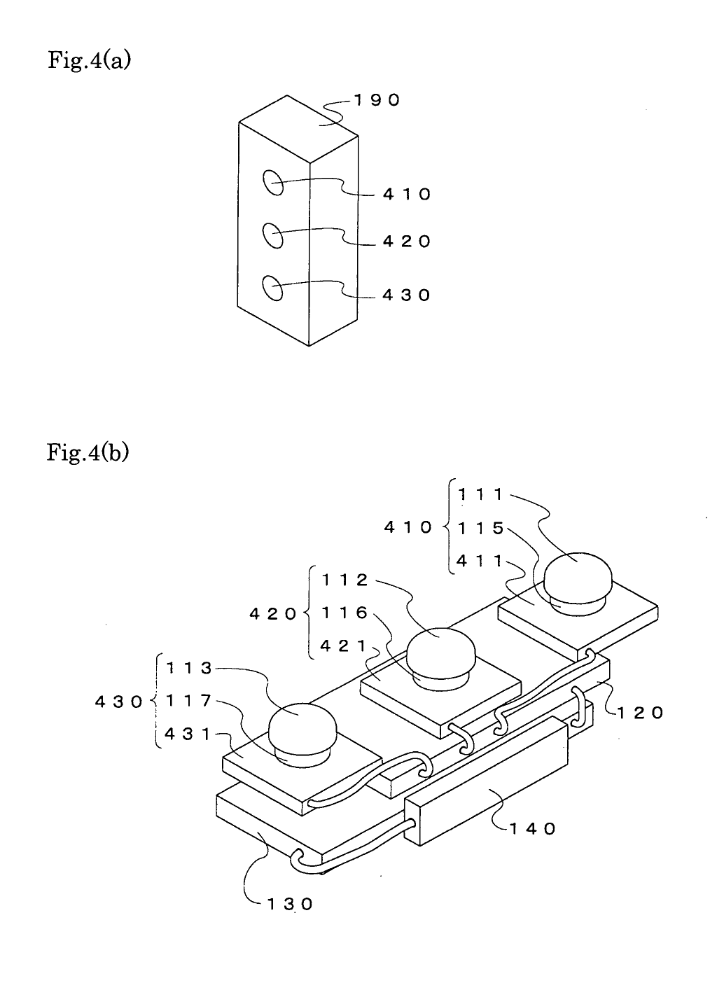

In an embodiment of the present invention, the sensor module part 110 comprises three pyroelectric elements 115 to 117, lens 111 to 113 mounted on each of the three pyroelectric elements, and a substrate (refer to FIG. 4) with a circuit such as an amplifier. The sensor module part 110 used in an embodiment of the present invention operates to convert change in amount of infrared rays from an object (a difference of energy of infrared rays between the object and its background (i.e. a temperature difference)) within a plurality of detecting areas detected by each of the pyroelectric elements to a voltage waveform to be output. In general, a detecting area, for example, consisting of 16 zones (4×4) is formed with a combination of one pyroelectric element and one lens, and an average value of change in amount of infrared rays detected in the detecting area consisting of 16 zones is output as one voltage waveform from one pyroelectric element. Thus, for example, in a case where the sensor module part 110 includes three pyroelectric elements and lenses, three voltage waveforms are output from the sensor module part 110 as changes in amount of infrared rays detected in the detecting area consisting of 48 zones (16×3) (the entire area is referred as a detecting range). A number of detecting areas and a range of each of the detecting areas differ for combinations of detecting elements and lenses. The pyroelectric elements 115 to 117, the lenses 111 to 113 and the substrate with a circuit such as an amplifier are same as those used in a well-known pyroelectric infrared sensor (so-called a passive sensor), and their detailed structure or fabricating method are not specifically described herein.

The lenses 111 to 113 are mounted on each of the pyroelectric elements 115 to 117. Arrangement of the three pyroelectric elements 115 to 117 and type of each of the lenses 111 to 113 are determined as such that a required detecting range is efficiently covered by a plurality of detecting areas of the pyroelectric elements 115 to 117. For example, in an embodiment of the present invention, the three pyroelectric elements 115 to 117 are arranged in a line. The lenses 111 to 113 mounted on each of the pyroelectric elements 115 to 117 are selected to allow for detecting appropriate areas corresponding to an object of motion discrimination or types of motions to be detected, such as, for example, a lens capable of narrowly detecting a longitudinal area but widely detecting a transverse area is used for a lens mounted on an upper pyroelectric element, a lens which a transverse detecting area thereof capable of detecting bedsides is used for a lens mounted on a center pyroelectric element and a lens capable of widely detecting in both longitudinal and transverse area is used for a lens mounted on a lower pyroelectric element.

In the present invention, various sensor conditions such as, for example, type, a number, rotating angle, sensitivity, and position of the pyroelectric elements 115 to 117, type and rotating angle of the lenses 111 to 113, and mounting angle of the sensor module part 110 are preferably optimized using a neural network so that characteristics corresponding to a motion of a patient etc. may be reflected in a voltage waveform. The mounting angle of the sensor module part 110 is a tilting angle with respect to a vertical direction of a plane formed by the plurality of senses 111 to 113 of the sensor module 110. In a motion discrimination system 190 according to an embodiment of the present invention which houses, in 1 case, the sensor module part 110, the analog/digital converting part 120, the analyzing/controlling part 130 and the communicating part, the angle is an angle with respect to the vertical direction of the motion discrimination system 190 itself. Optimizing sensor conditions will be described later. The number of pyroelectric elements and lenses of the sensor module part 110 is not limited to three, but one, two and 4 or more pyroelectric elements and lenses may be used.

Change in amount of infrared rays detected by the pyroelectric elements 115 to 117 is converted to a consecutive voltage value i.e. a voltage waveform for each of the pyroelectric elements 115 to 117 and is output from the sensor module part 110. As three pyroelectric elements 115 to 117 are used in an embodiment of the present invention, three consecutive voltage values (i.e. voltage waveforms of 3 channels) are output from the sensor module part 110.

The analog/digital converting part 120 operates to receive the voltage waveform output from the sensor module part 110, to sample the received voltage waveform at a predetermined rate and to process the received voltage waveform to data for a certain time length (quantized time-series data). A voltage value output from the sensor module part 110 is a consecutive analog data that changes in a range of, for example, 0 to 5V. On the other hand, an input to the motion discrimination model 135 of the motion discrimination part 131 included in the analyzing/controlling part 130 is required to be a digital data. Thus, the analog/digital converting part 120 is configured to convert the analog data output from the sensor module part 110 to a digital data (quantized data) suitable to be input to the motion discrimination model 135.

The analog/digital converting part 120 may convert each of the received 3-channel voltage waveforms at a sampling rate of, for example, 0.1 sec, so that, for example voltage waveform obtained in 4 seconds may be converted to 40 digital data (voltage values) per channel. In the embodiments of the present invention, the sampling rate is set, but not limited to, at 0.1 sec as a necessary time interval for sufficiently capturing characteristics of human motion, and may be, slower or faster than 0.1 sec. However, if sampling rate is too fast, calculation load may be too large to make real-time motion discrimination difficult, and if sampling rate is too slow, characteristics of motion may not be sufficiently captured. Thus, the sampling rate needs to be determined with consideration to those factors.

The analyzing/controlling part 130 comprises the motion discrimination part 131 for motion discrimination using the quantized time-series data. The motion discrimination part 131 comprises the optimized motion discrimination model 135 and a time-series analysis model 136, and receives data from the analog/digital converting part 120 to input the data to the optimized motion discrimination model 135 and outputs discrimination results of the motion discrimination model 135 or discrimination results of the motion discrimination model 135 and the time-series analysis model 136 to the communicating part 140. In an embodiment of the present invention, the motion discrimination model is a neural network. The analyzing/controlling part 130 further comprises a storing means 133 for storing a computer program that describes the motion discrimination model 135, the time-series analysis model 136 and a threshold value determining means 137 as well as various computer programs and data necessary for operation of the motion discrimination system 190 according to the present invention, and a controlling part 132 having a CPU (Center Processing Unit) for controlling an entire operation of the motion discrimination system according to the present invention and performing various calculation processes. The analyzing/controlling part 130 is preferably achieved by using a computer system that uses, for example, an ARM architecture used for embedded equipments, but may also be achieved using a versatile personal computer system.

The communicating part 140 transmits motion discrimination results output from the analyzing/controlling part 130 to the data server 150. A communication between the communicating part 140 and the data server 150 may either be wireless or wired communication. The data server 150 records, to the database 151, at least received discrimination results, their time of receipt and motion discrimination IDs used for determining which of a plurality of motion discrimination system the discrimination results are received therefrom, as well as transmits the received discrimination results to a mobile information terminal 160 in a remote location such as, for example, a nurse station. The data server 150 may be configured with a computer system such as a main frame or a server. In a case where an object of motion discrimination is a patient on a bed, receiving discrimination results with the mobile information terminal 160 allows for real-time comprehension of rising, falling or leaving of the patient from the bed by a nurse who carries the mobile information terminal 160. In another embodiment of the present invention, motion discrimination results output from the analyzing/controlling part 130 may be directly transmitted to the mobile information terminal 160 via the communicating part 140.

Herein, an embodiment where a motion discrimination system 190 in which the sensor module part 110, the analog/digital converting part 120, the analyzing/controlling part 130 and the communicating part 140 are housed in 1 case, is described. However, the system and the devices according to the present invention are not limited to such configuration, but each of the sensor module part 110, the analog/digital converting part 120, the analyzing/controlling part 130 and the communicating part 140 may be configured as a separate device, or some of the parts may be configured as an integral device, and each of the devices and the data server 150 may be mutually connected by wireless or wired communication. In such embodiment, the sensor module part 110 alone, or a device housing the sensor module part 110 and some of other parts in 1 case, may be a sensor device arranged above a bed which a patient is lying thereon as will be described later, and other components may be configured integrally or separately, either as a device arranged close to the bed or a device arranged remote from the bed.

### 2. Processing in an Optimized Motion Discrimination System

### (Outline of Processing)

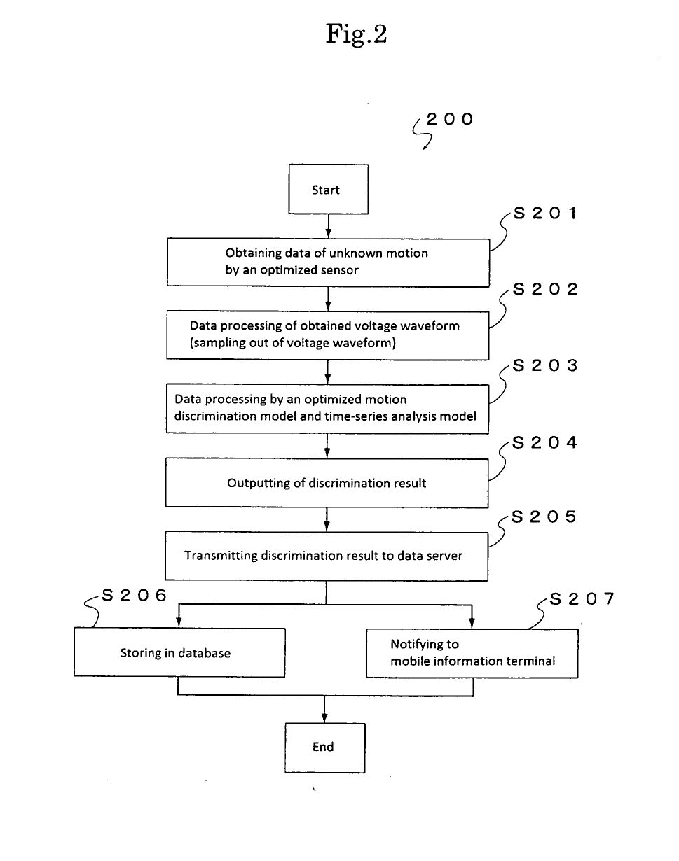

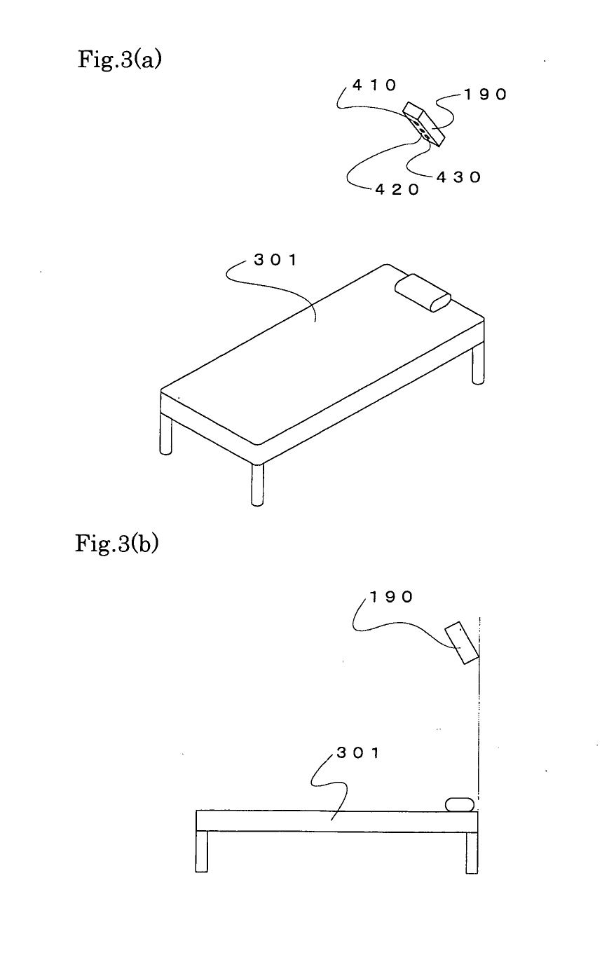

FIG. 2 is a schematic flowchart 200 showing a process for discriminating an unknown motion by a patient etc in real-time by the motion discrimination system 110 including an optimized motion discrimination system 190, according to an embodiment of the present invention. The motion discrimination system 190, which various sensor conditions thereof such as type, a number, position, rotating angle, sensitivity of pyroelectric elements, type and rotating angle of lenses and mounting angle of a sensor module part are optimized in advance, is mounted above a bed which a patient etc is lying thereon. FIG. 3 is a view illustrating the optimized motion discrimination system 190 mounted above a bed 301 which a patient etc is lying thereon. A motion of the patient etc. on the bed 301 is detected by the sensor module part 110 of such mounted motion discrimination system 190, and a voltage waveform data showing characteristics corresponding to type of the motion is output (s201).

The voltage waveform data output from the sensor module part 110 is input to the analog/digital converting part 120 to be processed to a quantized time-series data (s202). The quantized time-series data is input to the optimized motion discrimination model 135 of the motion discrimination part 131 to be processed for motion discrimination (s203). In order to obtain more accurate discrimination result, motion discrimination may be performed using not only the motion discrimination model 135, but additionally a time-series analysis model 136 that further analyzes the result from the motion discrimination model 135 for outputting the discrimination result. When a processing, by the optimized motion discrimination model 135, or by the optimized motion discrimination model 135 and the time-series analysis model 136, is finished, a discrimination result of motion of a patient etc. is output from the motion discrimination part 131 (s204). The discrimination result is transferred to the communicating part 140 that transmits the discrimination result to the data server 150 with wireless or wired communication (s205). The data server 150 stores the discrimination result with a date of receipt and a motion discrimination system ID in the database 151 (s206), and notifies the discrimination result to the mobile information terminal 160 by, for example, audio or text, depending on necessity (s207).

### (Optimized Motion Discrimination System)

FIG. 4 (a) is a schematic diagram illustrating an exterior of an optimized motion discrimination system, and FIG. 4 (b) is a schematic diagram illustrating a configuration of an optimized motion discrimination system, according to an embodiment of the present invention. In an embodiment of the present invention, the motion discrimination system 190 has 3 passive sensors 410, 420 and 430. Each of the passive sensors 410, 420 and 430 respectively comprises lens 111, 112 and 113, pyroelectric elements 115, 116 and 117 and substrates 411, 421 and 431. Each of detecting areas of the passive sensors 410, 420 and 430 may be, for example, set as the following by appropriately selecting respective lenses 111, 112, 113.

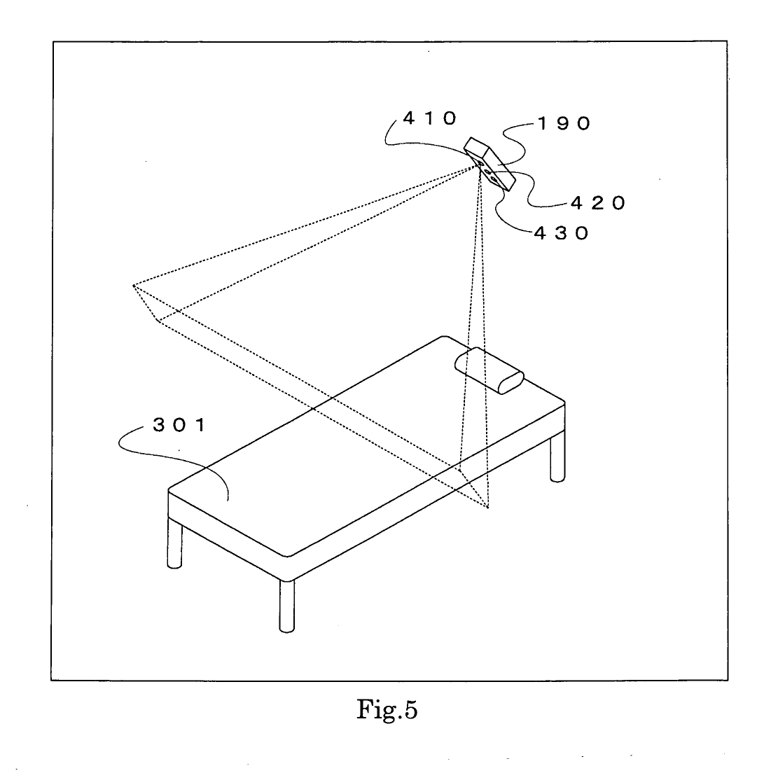

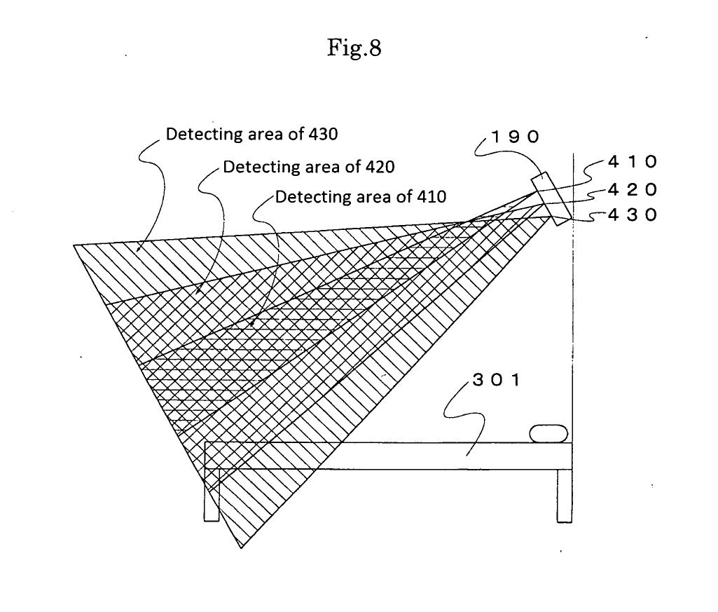

Passive sensor 410: A lens, which a longitudinal detecting area thereof is narrow and a transverse detecting area thereof is wide, is used to set the detecting area cover across upper half of body of a patient when rising from a bed (FIGS. 5 and 8).

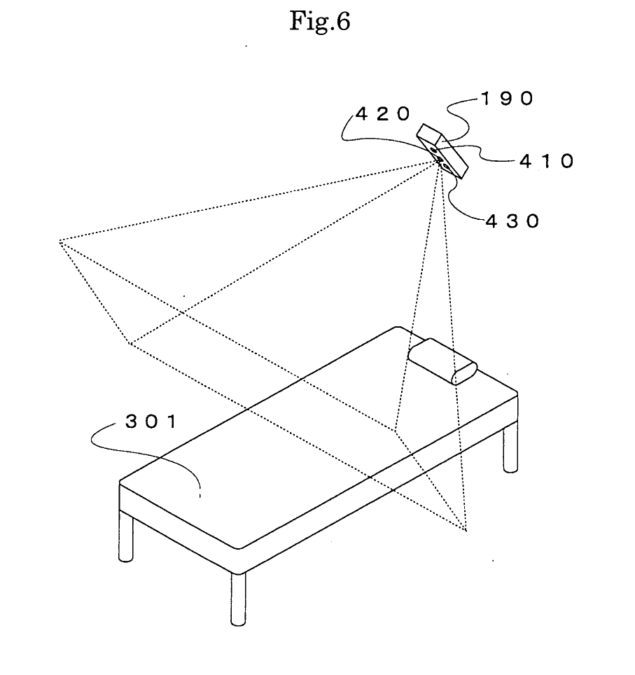

Passive sensor 420: A lens, which a transverse detecting area thereof covers bedsides, is used to set the detecting area cover an area capable of detecting a patient falling from a bed (FIGS. 6 and 8).

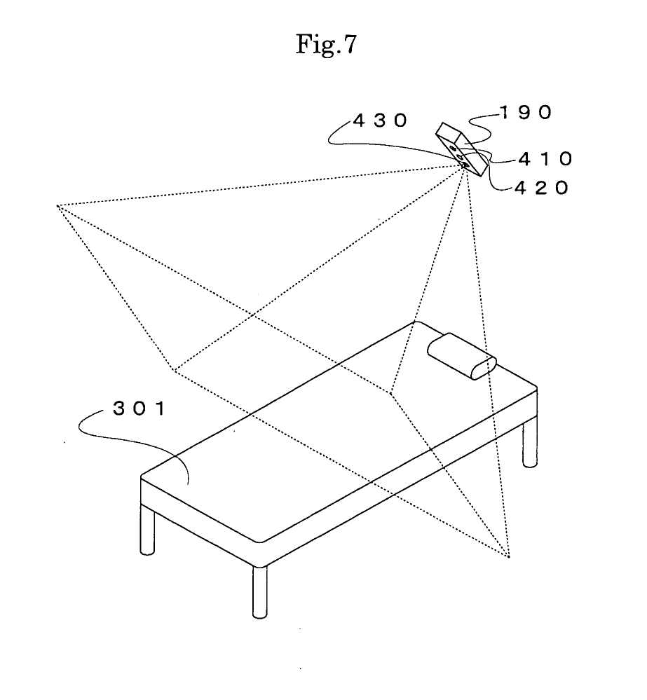

Passive sensor 430: A lens capable of widely detecting longitudinal and transverse area is used to set the detecting area capable of detecting a patient leaving a bed (FIGS. 7 and 8).

Herein, data output by the passive sensors 410, 420 and 430 may be that of channel 1 (ch1), channel 2 (ch2) and channel 3 (ch3), respectively.

The passive sensors 410, 420 and 430 convert change in amount of infrared rays from a patient etc. in each of detecting areas of the passive sensors 410, 420 and 430 to a voltage value for outputting. Each of detecting areas of the passive sensors 410, 420 and 430 is, as well-known in the art, configured with a plurality of detecting zones so that the passive sensors 410, 420 and 430 can generate different voltage waveforms corresponding to a direction and speed when a patient etc. or a part thereof crosses some of the plurality of detecting zones.

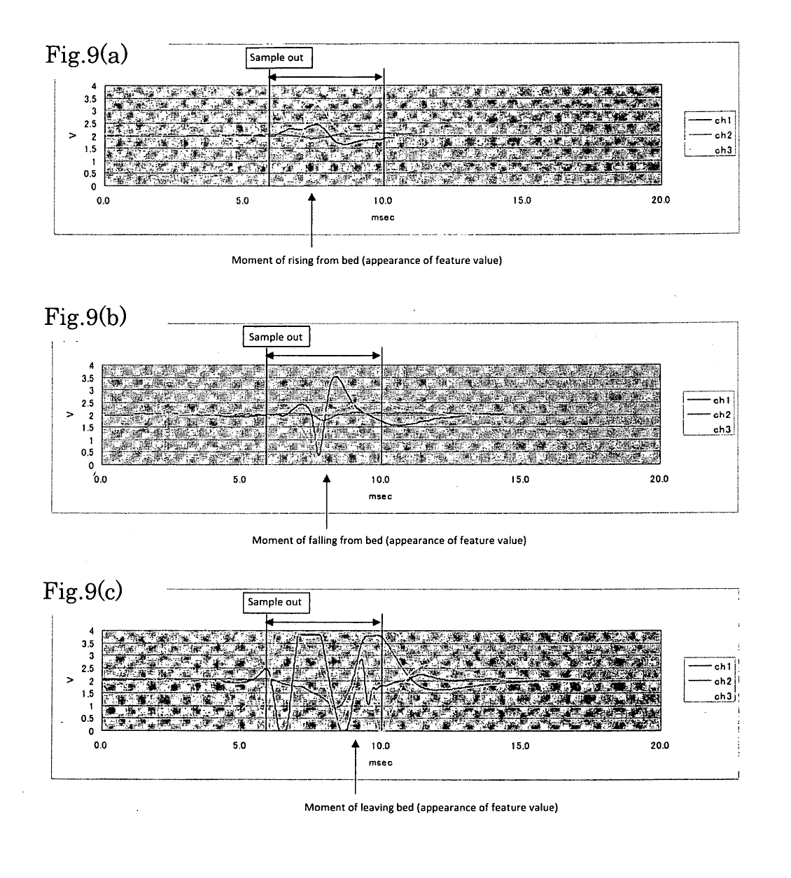

FIG. 9 shows examples of voltage waveforms output by the sensor module part 110 of the optimized motion discrimination system 190, according to an embodiment of the present invention. FIG. 9 (a) is an example of voltage waveform generated during a several seconds including before and after a moment of a patient etc. rising from a bed, FIG. 9 (b) is an example of voltage waveform generated during a several seconds including before and after a moment of a patient etc falling from a bed, and FIG. 9 (c) is an example of voltage waveform generated during a several seconds including before and after a moment of a patient etc. leaving from a bed and starting to walk. FIG. 9 shows that different voltage waveforms are output from each of ch1 to ch3 corresponding to different motions of a patient etc. The voltage waveforms may not clearly reflect unique characteristics of respective motion depending on the sensor conditions even when types of motion are different, then accurate discrimination results may not be obtained by inputting such voltage waveforms to the motion discrimination model. To address the above, the present invention is characterized in that the sensor conditions are optimized in advance so that unique characteristics of the motion are clearly reflected on a voltage waveform generated corresponding to types of known motions, and different voltage waveforms are then generated for unknown motions by the sensor module part which conditions thereof are optimized as above so that characteristics of the unknown motions are extracted from the generated voltage waveforms using the optimized motion discrimination model to allow for discriminating types of motions.

### (Data Processing)

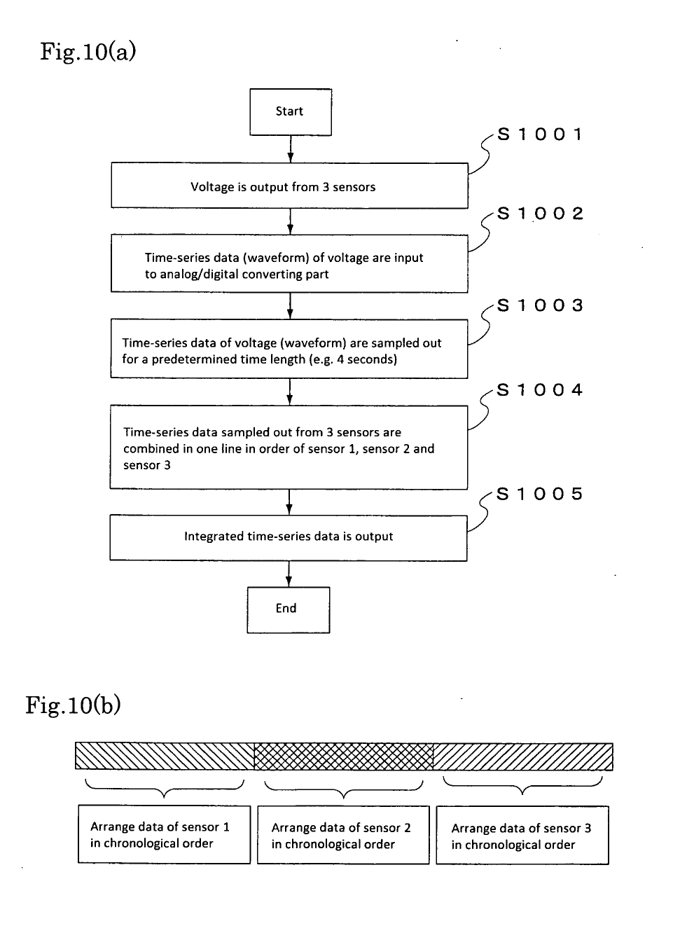

The 3 channel voltage waveforms output from the passive sensors 410, 420 and 430 reflecting characteristics of motions are then input to the analog/digital converting part 120 to be processed into data in a form appropriate for inputting to the motion discrimination model 135 (s202 in FIG. 2). FIG. 10 shows a schematic flowchart (a) illustrating processing of a voltage waveform and a schematic diagram (b) illustrating data after processing, according to an embodiment of the present invention. Referring to FIG. 10 (a), consecutive voltage values (i.e. voltage waveforms) are first output from each of the passive sensors 410, 420 and 430 to be input to the analog/digital converting part 120 (s1002).

The voltage waveforms input to the analog/digital converting part 120 are divided at a predetermined time length, for example every 4 seconds, necessary to accurately obtain final motion discrimination results (s1003). The predetermined time length is not limited to 4 seconds, and it is preferable to select an appropriate time length covering start to end of change of a voltage waveform from the sensor module part 110 generated depending on a motion of a patient etc. In a case where the predetermined time length is 4 seconds, input waveforms are sampled at a rate of, for example, 0.1 second in the analog/digital converting part 120, to allow for obtaining 40 data per channel in 4 seconds, i.e. a group of data in a unit of 120 data for 3 channels is obtained (hereinafter, a group of data, in which consecutive voltage waveforms are sampled at a predetermined rate and a plurality of sampled data included in a predetermined time length is handled as a unit, may be referred as “a case”). Motion discrimination by the motion discrimination model 135 is performed at every 0.1 second.

A first motion discrimination uses 40 data for each channel (1 case of 120 data for 3 channels). Subsequently, 1 data for the oldest 0.1 second among the first 40 data in each of the channels is discarded to leave 39 data for each channel, and 1 data for 0.1 second next to the first 4 second is newly added for each of the channels to have 40 data for each channel again. Next motion discrimination is performed with the new 40 data/channel (1 case of 120 data for 3 channels). By repeating such processing for every 0.1 second, motion discrimination may be performed at every 0.1 second (In other words, by updating data at every 0.1 second while keeping waveform data for 4 seconds, 1 motion discrimination is performed at every 0.1 second using the data for 4 seconds. Between 120 data for 3 channels for 4 seconds before updating and those after updating, 117 data are common.). The data for 3 channels obtained by dividing at a predetermined time length are then combined in 1 line in order of ch1, ch2 and ch3 to be reconfigured as a quantized time-series data shown in FIG. 1 (b) (s1004). The reconfigured data are output to the analyzing/controlling part 130 (s1105) and data processing is terminated.

### (Motion Discrimination Processing)

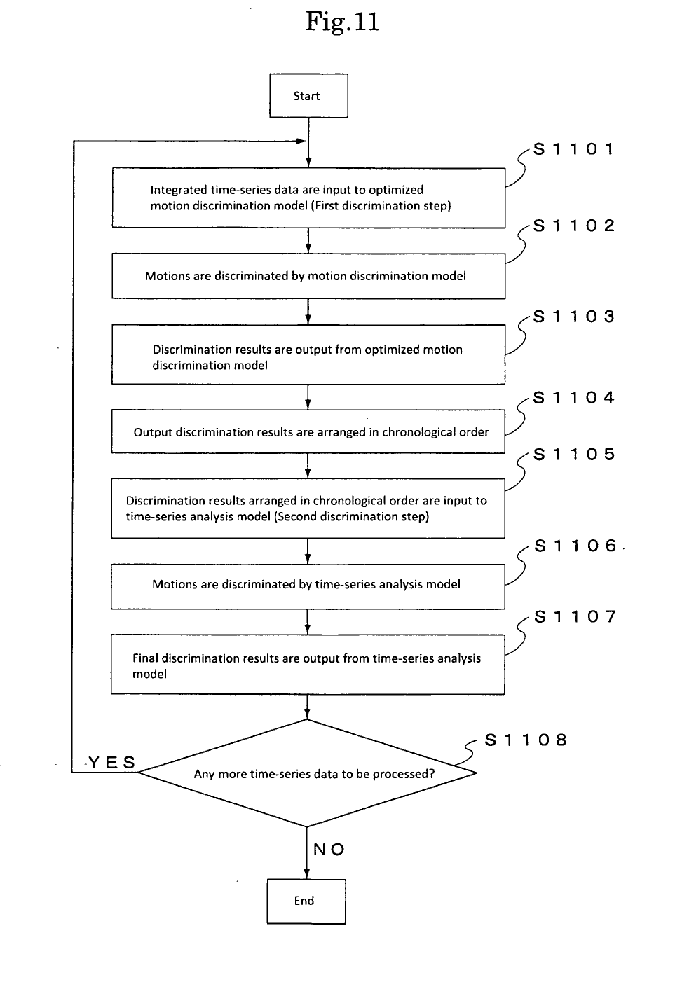

The quantized time-series data obtained by the processing shown in FIG. 10 (a) are then input to the motion discrimination part 131 of the analyzing/controlling part 130. FIG. 11 is a schematic flowchart illustrating a motion discrimination processing performed with the optimized motion discrimination model 135 and the time-series analysis model 136 included in the motion discrimination part 131. When a processing is started, the quantized time-series data are first input to the optimized motion discrimination model 135 of the motion discrimination part 131 (s1101) for motion discrimination (s1102), and discrimination results are output (s1103).

### (Optimized Motion Discrimination Model)

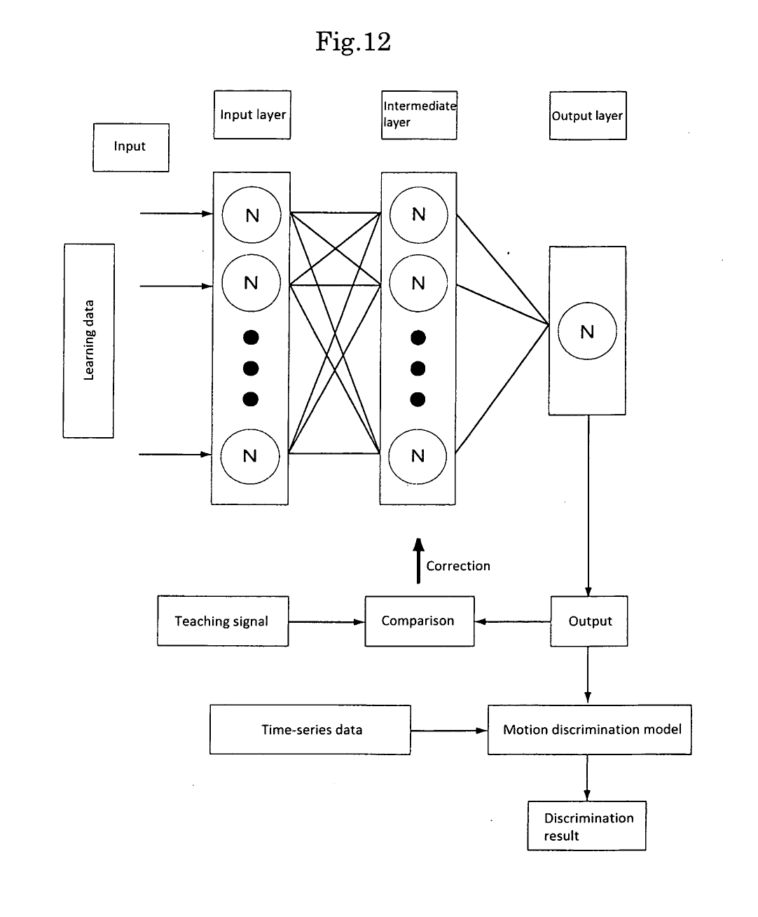

In an embodiment of the present invention, a neural network is preferably used as the motion discrimination model 135. FIG. 12 is a schematic diagram illustrating a multilayer neural network used as the optimized motion discrimination model 135 in an embodiment of the present invention. The multilayer neural network consists of sets of processing elements (the element indicated as “N” in FIG. 12) so-called neuron or node arranged in 2 or more layers. The multilayer neural network normally has at least one hidden intermediate layer sandwiched between an input layer and an output layer. The input layer has neurons for determining output values to the intermediate layer depending on presented input patterns, and the output layer has neurons for determining final output values i.e. discrimination results for the output from the intermediate layer. Inputs to neurons in each of the layers depend on outputs from a previous layer. Thus, output of a predetermined neuron in the multilayer neural network is a function of input to the neuron.

Generally, when an input vector to a neuron is x=(x₁, . . . , xᵢ, . . . x_{M}) and an output is y, then an operation of the neuron can be represented by the following equation.

$$y = H [ {\sum }_{i = 1}^{M} {w}_{i } {x}_{i} - θ ] \qquad ( Equation 1 )$$

Here, wᵢ is referred as a combination weight for input element x₁ and θ is referred as a threshold value of neuron. H [ ] is a function referred as a threshold function, a step function or Heaviside function, and when a value in [ ] is positive, the function takes a value of 1, and when negative, the function takes a value of 0. Sigmoid function is often used as a threshold function. Thus, the neuron outputs 0 when a sum of weighted inputs is smaller than the threshold value and outputs 1 when the sum exceeds the threshold value. For an accurate motion discrimination, the weight vector w=(x₁, . . . , wᵢ) and the threshold value θ are required to be determined appropriately. A procedure for correcting w and/or θ is referred as a learning algorithm of a neural network, and a degree of correction is referred as a learning rate. The following are examples of representative learning algorithm that are referred as error-correction learning.

(1) An initial value of w is determined as a random value that is not 0.

(2) One data x is randomly selected from learning data and is input, and an output of a neural network is calculated using a current value of w to indicate a discrimination result.

(3) Only when the discrimination result is false, the values of w and/or θ are corrected toward a direction for making the result correct.

In an embodiment of the present invention, various parameters such as a number of neurons in the input layer, a number of intermediate layers and/or a learning rate are adjusted to output correct discrimination result based on known motions simulating a motion to be discriminated so that the optimized motion discrimination model 135 can be obtained. Optimizing the motion discrimination model will be described later.

The motion discrimination model 135 according to an embodiment of the present invention is preferably an aggregate of a plurality of optimized motion discrimination models for each of a plurality of motions to be discriminated. For example, when motions to be discriminated are 3 types as rising (a rising motion of a upper body from a bed), falling (a falling motion from a bed) or leaving (a leaving motion from a bed) of a patient etc., then the motion discrimination system 190 preferably performs a final motion discrimination using a rising-discriminating model optimized to discriminate between a rising motion and a non-rising motion (for example, turning, raising an arm, raising a leg, etc.), a falling-discriminating model optimized to discriminate between a falling motion and a non-falling motion (for example, leaving a bed and start walking, etc.), and a leaving-discriminating model optimized to discriminate between a leaving motion and a non-leaving motion (for example, moving a body on a bed without leaving therefrom, etc.). Naturally, in another embodiment of the present invention, only 1 motion discrimination model 135 capable of discriminating 3 or more types of motions may be incorporated in the motion discrimination system 190 to discriminate 3 types of motions such as rising, falling and leaving by said model 135. However, in such an embodiment, the motion discrimination accuracy may be deteriorated when compared with an embodiment where an aggregate of a plurality of discrimination models corresponding to types of motions is used as the motion discrimination model 135.

In an embodiment where a plurality of optimized motion discrimination models 135 is used, the plurality of motion discrimination models 135 may be coupled in series or in parallel for use. For example, in a case where 3 motion discrimination models 135 for discriminating rising, falling and leaving from a bed are used in series, an obtained data first are input to a rising-discriminating model, then if the result is discriminated as rising, the same data may be input to a falling-discriminating model, and if the result is discriminated as falling, the same data may be input to a leaving-discriminating model. In a case where 3 models are coupled in parallel, an obtained data may be simultaneously input to each of a rising-discriminating model, a falling-discriminating model and a leaving-discriminating model to obtain a final discrimination result as either of rising, falling or leaving, or a combination thereof. In either case, since a motion discrimination processing and an optimizing method thereof are same in each of the plurality of motion discrimination models 135, an embodiment of the present invention will be described in the following using 1 motion discrimination model 135 for discriminating between a rising motion and a non-rising motion.

Back to FIG. 11, discrimination results are output from 1 or a plurality of optimized motion discrimination models 135 (s1103). Motion discrimination results being output are acquired by inputting data obtained by using the optimized sensor module part to the optimized motion discrimination models 135, and thus, they already indicate results of accurate discrimination of motions of a patient etc. But the present invention allows for obtaining more accurate discrimination results by further using the time-series analysis model 136 (s1104 to s1107 in FIG. 11) that analyzes a time-series relationship between a plurality of discrimination results obtained as above.

### (Optimized Time-Series Analysis Model)

In an embodiment of the present invention, the time-series analysis model 136 may be configured to determine that a motion is rising from a bed when a plurality of discrimination results, for example, N discrimination results output from the motion discrimination model 135 include M times of motion discriminated as rising from a bed and L times of motion that consecutively discriminated as rising from a bed. Values of N, M, and L are adjusted in advance so that correct discrimination results may be output based on a known motion simulating a motion to be discriminated. This means that the time-series analysis model used in the motion discrimination system 190 is an optimized time-series analysis model. In an embodiment of the present invention, the values of N, M and L of the optimized time-series analysis model 136 are N=30, M=20 and L=10. Subsequently, final discrimination results are output from the time-series analysis model 136 (s1107), and if there are time-series data to be further processed, the step returns to s1101 for further discrimination processing, or if there is no time-series data to be further processed, the motion discrimination processing is terminated.

### (Detail of Motion Discrimination Processing)

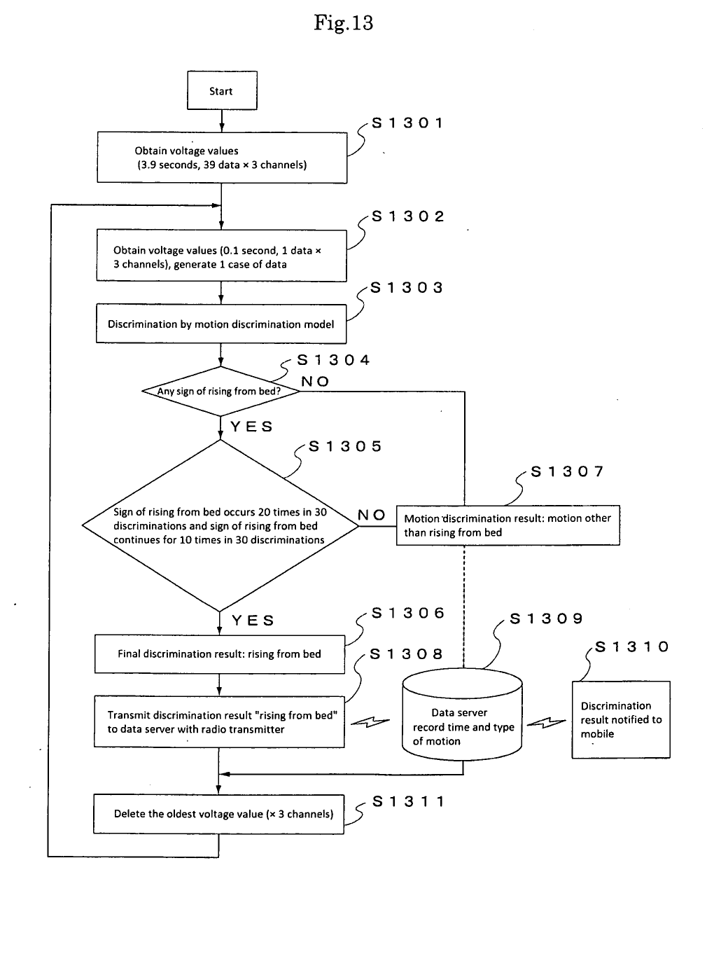

FIG. 13 is a flowchart illustrating in more detail the processes s1101 to s1108 in FIG. 11 according to an embodiment of the present invention. Detail of processing to discriminate, for example, a rising motion from a bed will be described in the following with reference to FIG. 13. First, 39 time-series data (voltage values) for each channel (117 data for 3 channels) sampled from a voltage waveform at every 0.1 second for 3.9 seconds are obtained by the analyzing/controlling part 130 and stored in, for example, the storing means (a memory) 133 provided in the analyzing/controlling part 130 (s1301). Then, the analyzing/controlling part 130 obtains a data for the newest 0.1 second for each of channels and adds the data at the end of the 39 data for 3.9 seconds in each channel to generate 40 data for each of 3 channels (1 case) (s1302). These data are configured to be a time-series data (refer to FIG. 10 (b)) lined in order of channels such as 40 data (ch1)—40 data (ch2)—40 data (ch3) and are input to the motion discrimination model 135.

The 120 data are input to the optimized motion discrimination model 135, i.e. the input layer of the neural network to be processed by the neural network, then, the motion discrimination results are output from the output layer (s1303). For example, in case where a motion to be discriminated is rising from a bed, if a flag output from the rising-motion discriminating model 135 is 1 (TRUE), the motion is discriminated as a forecasted rising, and if the flag is 0 (FALSE), the motion is discriminated as not a forecasted rising (s1304). This 1 discrimination result is obtained as a result of processing a group of data in which the above 40 data for 3 channels=120 data in 1 unit by the neural network. In an embodiment of the present invention, 1 discrimination result is output at every 0.1 second using data updated at every 0.1 second, i.e. data for a period of 4 seconds shifted for 0.1 second at every 0.1 second.

The motion discrimination results as such consecutively output are sequentially input to the time-series analysis model 136 to be counted for a number N that is a sum of motion discrimination results discriminated as forecasted rising and results discriminated as other than rising, a number M that is a number of motion discrimination results discriminated as forecasted rising and a number of L that is a number of motion discrimination results consecutively discriminated as forecasted rising. Then the time-series analysis model 136 determines whether the motion is to be finally discriminated as a forecasted rising or not, using N, M and L (s1305). In an embodiment of the present invention, in a case where a number of discrimination results discriminated as forecasted rising is 20 or more, and, a number of discrimination results consecutively discriminated as forecasted rising is 10 or more, among a sum of 30 discrimination results, the motion is finally discriminated as rising from a bed (s1306). The values of N, M and L are parameters affecting to accuracy of discrimination results, and therefore, they may be adjusted in advance and optimized by selecting a combination of N, M and L which achieves highest possible accuracy of final discrimination results.

### (Recording and Notifying of Motion Discrimination Result)

When a motion is discriminated as rising from a bed by the above motioned discrimination model 135 and the time-series analysis model 136 (s1306), as well as when a motion is discriminated as not a forecasted rising in s1304 and as not rising in s1305 (s1307), the discriminations results are transferred to the communicating part 140 and transmitted therefrom to the data server 150 via wired or wireless communication (s1308). The data server 150 stores discrimination results, time of receiving and motion discrimination system ID in the database 151 (s1309), as well as notifies the discrimination results to the mobile information terminals 160 (s1310). This notifying may be performed only when a motion is discriminated as rising from a bed, or may be performed for each of discriminations.

### (Next Motion Discrimination)

Subsequently, the analyzing/controlling part 130 discards the oldest voltage value from the 40 data in each of the channels stored in the storing means 133 of the analyzing/controlling part 130 and used for motion discrimination as above (s1310), then, the step returns to s1302. The analyzing/controlling part 130 add a new voltage value for the next 0.1 second to the data in each of the channels to generate new 40 data in each channel for 3 channels and re-stores in the storing means 133. Processes of s1302 to s1310 are repeated using such generated new data.

### 3. Optimizing Sensor Module Part

The present invention is what discriminates motions of a patient etc. by inputting voltage waveforms representing characteristics corresponding to different motions of the patient etc to motion discrimination models. This means that if sensor conditions such as a number of the sensors and types of lenses are not appropriately set, voltage waveforms may not sufficiently reflect unique characteristics of respective motion even when types of detected motions are different, and accurate discrimination results may not be obtained by inputting such voltage waveforms to motion discrimination models. To address this, the sensor module part 110 in the motion discrimination system 190 according to the present invention is preferably optimized in advance such that unique characteristics of respective motion are reflected on voltage waveforms generated corresponding to types of motions. In an embodiment of the present invention, a neural network is used for optimizing the sensor module part 110.

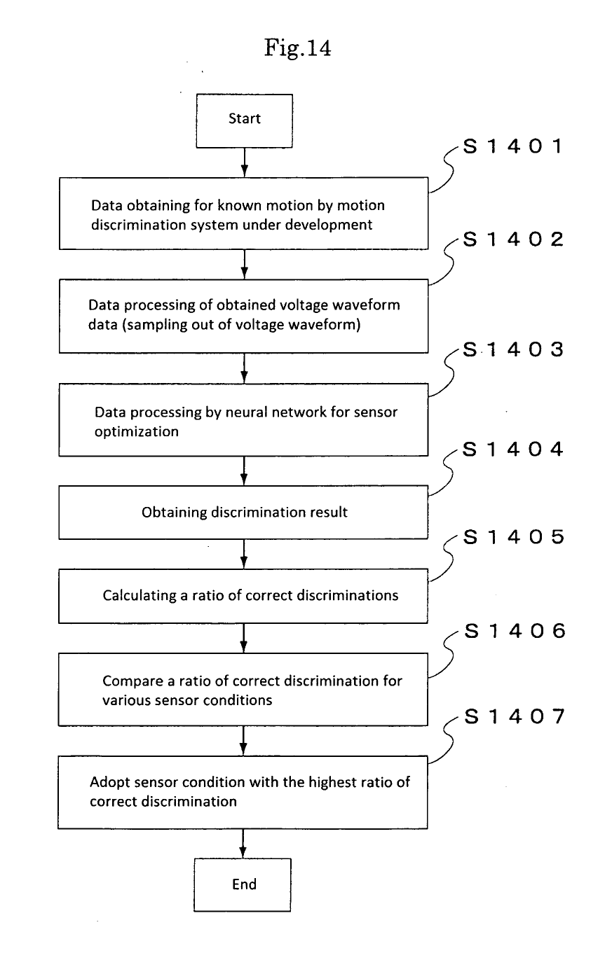

FIG. 14 shows a procedure for optimizing the sensor module part 110, according to an embodiment of the present invention. A known motion performed by a test subject simulating a motion of a patient etc. to be discriminated is detected by the motion discrimination system 190 which the sensor module 110 thereof is yet to be optimized, arranged as shown in FIG. 3 for example, and a voltage waveform data corresponding to the known motion is output (s1401). For the motion discrimination system 190 which the sensor module 110 thereof is yet to be optimized, various sensor conditions such as a number of passive sensors included in the sensor module part 110, types of pyroelectric elements 115 to 117 used for the passive sensors 410 to 430, rotating angle of the pyroelectric elements 115 to 117, sensitivity of the pyroelectric elements 115 to 117, types lenses 111 to 113 mounted on the pyroelectric elements 115 to 117, rotating angle of the lenses 111 to 113, distance between the passive sensors (i.e. positions of the passive sensors), and tilting angle of the sensor module part with respect to a vertical direction, are set accordingly. The initial settings of sensor conditions are preferably set to logically forecasted conditions based on each of nature of sensor conditions and types of motion to be discriminated.

There are types for the pyroelectric elements 115 to 117 such as dual elements having 2 sets of electrodes with opposite polarities and quad elements having 4 sets of electrodes with different polarities. Types, rotating angle and sensitivity of the pyroelectric elements 115 to 117 are preferably considered as sensor conditions because their setting conditions may affect detecting accuracy based on moving direction of a detecting object i.e. a heat source. A number of the passive sensors 410 to 430, types and rotating angle of the lenses 111 to 113, distance between the sensors, and tilting angle of the sensor module part 110 with respect to vertical direction are preferably considered as sensor conditions because their setting conditions may vary detecting range to be covered, and thus may affect detecting accuracy.

The output voltage waveform data are processed and become quantized time-series data through a similar processing as the aforementioned processing (FIG. 10) by the analog/digital converting part 120 (s1402). Here, the analog/digital converting part 120 generates time-series data as data to which data indicating a type of motion (“teaching signals” used in neural network technique) is added for every case. These data are also referred as data for learning. The data for learning are generated by adding an information (for example, a flag) indicating types of motions of a test subject recorded with a camera or by human observation when obtaining the voltage waveforms, to the end of the 120 time-series data processed from the voltage waveform data obtained from the sensor module part 110 (i.e., in the present embodiment, a number of data included in 1 case of data for learning is 121).

The generated data for learning are input to a neural network for optimizing sensors which is similar to that shown in FIG. 12 and are processed (s1403). In the neural network for optimizing sensors, learning processes such as the following are performed. First, data for learning are input to the input layer of the neural network for optimizing sensors. It is preferable to prepare more than a few hundred cases (i.e., a few hundred of data groups in a unit of 40 data for each channel (120 data for 3 channels) for 4 seconds plus teaching signals) of data for learning. One (1 case) of the prepared data for learning is input to the input layer for data processing by the neural network for optimizing sensors and the discrimination results are output from the output layer. Then, the output discrimination results and data (teaching signals) of types of motions included in the input data for learning are compared, and when the discrimination results and the types of motions included in the data for learning do not match, then, coefficients for the neural network for optimizing sensors, i.e., the weight w and/or the threshold value θ is corrected.

Subsequently, next case of data for learning is input to the input layer for similar discrimination processing and for correcting the coefficient according to necessity. This process is repeated until correct discrimination results are obtained (for example, until an improvement rate of accurate discrimination rate becomes constant), to eventually form the neural network for optimizing sensors. Learning process of a neural network may be configured to be performed using commercially available software (for example, “Clementine” available from SPSS Japan Inc. in Tokyo), and determining whether or not a correct discrimination result is obtained may be configured to be automatically done by the software.

Verifying data are then sequentially input to the neural network for optimizing sensors which the weight w of neurons and/or the threshold value θ thereof is appropriately adjusted as above. Time-series data different from those used for data for learning are preferably used as the verifying data. A number of the verifying data is preferably a few hundred cases. Discrimination results are output from the neural network for optimizing sensors according to input of the verifying data (s1404).

Next, a ratio of results correctly discriminated motions as a motion to be discriminated among a plurality of discrimination results output from the neural network for optimizing sensors is calculated (s1405). For example, if a motion to be discriminated is rising from a bed, when a number of data generated for a rising motion is N cases and a number of data generated for motions other than rising is M cases among the verifying data, N and M cases of data are input to the neural network for optimizing sensors. Here, let a number of outputs, obtained as a result of input of N cases of data generated for a rising motion and discriminated as rising (i.e., correct discriminations) be A, and a number of outputs discriminated as other than rising (i.e., incorrect discriminations) be B. Similarly, let a number of discrimination results, for M cases of data generated with motions other than rising and discriminated as rising (i.e., incorrect discriminations) be C, and a number of discrimination results discriminated as other than rising (i.e., correct discrimination) be D. Then, a ratio of results correctly discriminated as rising is A/N, and a ratio of results correctly discriminated as other than rising is D/M.

Next, the above steps s1401 to 1405 are repeated while appropriately varying the sensor conditions of the sensor module part 110 so that the sensor conditions become promising based on, for example, waveforms. Values of A/N and D/M for each of variations of the sensor conditions are compared (s1406), and the sensor conditions which achieved larger values of A/N and D/M are adopted as the sensor conditions of the optimized sensor module part 110 (s1407). In this case, when 2 sensor conditions, for example P and Q, are compared as a determining standard to adopt sensor conditions, if P is larger for both of A/N and D/M, it may be configured to adopt the sensor condition P. In another case, if the sensor condition P is larger for A/N but the sensor condition Q is larger for D/M, it may be configured to adopt P or Q based on a ratio, i.e. (A+D)/(N+M), of cases correctly discriminated as a whole.

After determining optimum sensor conditions for discriminating 1 type of motion, it is required to determine optimum sensor conditions for discriminating other types of motions. In an embodiment of the present invention for discriminating rising, falling and leaving from a bed of a patient, it is preferable to first adjust sensor conditions for discriminating a rising motion that is a start of all other motions when a sequence of actual motions is considered, then to adjust sensor conditions for falling and leaving as long as it does not adversely affect to discriminating of a rising motion.

### 4. Optimizing of Motion Discrimination Model

The present invention is, as described above, what discriminates motions from outputs of the motion discrimination model 135 which voltage waveforms from a plurality of the passive sensors 410 to 430, reflecting characteristics corresponding to different motions of a patient etc and output, are input thereto. However, even if data detected by the optimized sensor module part 110 and generated from voltage waveforms reflecting characteristics corresponding to different motions of a patient etc. were input to the motion discrimination model 135, accurate discrimination results may not be obtained unless parameter conditions of the motion discrimination model 135 were optimized. Thus, in the motion discrimination system 190 according to the present invention, it is preferable that the previously optimized motion discrimination model 135 is used such that each of motion discriminations is accurate when time-series data generated from voltage waveforms reflecting unique characteristics of each type of motions are input.

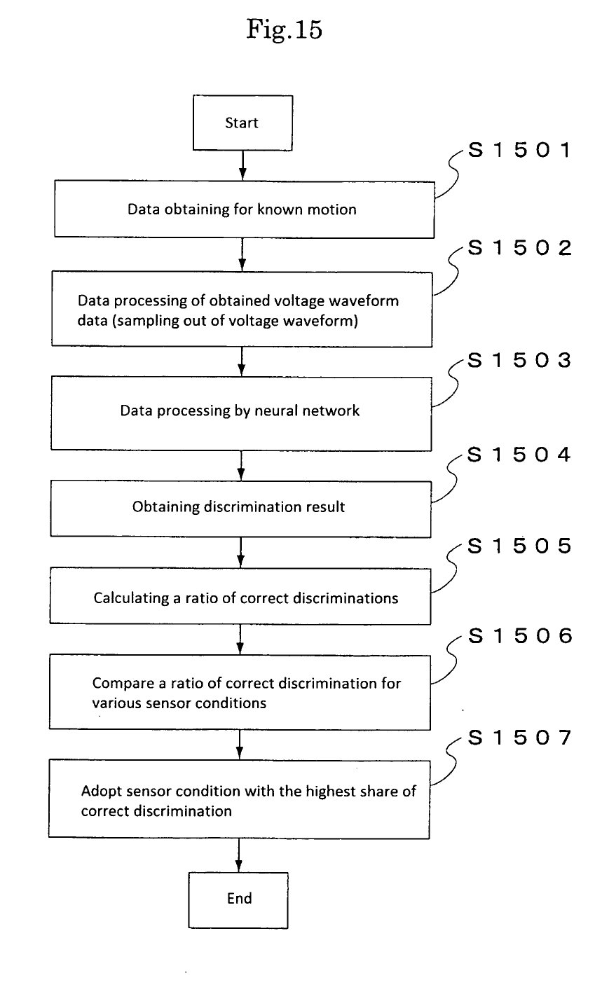

FIG. 15 shows a procedure for optimizing the motion discrimination model 135 configured with a neural network in an embodiment of the present invention. In the procedure, first, a known motion performed by a test subject simulating a motion of a patient etc. to be discriminated is detected by the sensor module part 110 of the motion discrimination system 190 arranged as shown in FIG. 3 for example, and a voltage waveform corresponding to the known motion is output (s1501). It is preferable that the sensor conditions are optimized for the sensor module part 110 of the motion discrimination system 190 that is used here, but the sensor module part 110 which the sensor conditions thereof are not optimized may also be used. When the sensor module part 110 which the sensor conditions thereof are not optimized is used, by alternatively performing optimizing of the motion discrimination model 135 and optimizing the sensor conditions as described herein, the motion discrimination model 190, which the sensor module part 110 and the motion discrimination model 135 thereof are finally optimized, may be obtained. Various parameter conditions such as a number of neurons in the input layer, a number of the intermediate layers and a learning rate may be accordingly set for a motion discrimination model i.e. a neural network before optimization. The initial setting of the parameter conditions are preferably set at logically forecasted values based on motions to be discriminated.

Output voltage waveform data are processed and become quantized time-series data through a similar processing as described above (FIG. 10) by the analog/digital converting part 120 (s1502). Similarly as for optimizing the sensor module part 110, the analog/digital converting part 120 generates time-series data as data for learning to which data indicating a type of motion (“teaching signals”) is added to every case. It is preferable that more than a few hundred data for learning are prepared. Then, one (1 case) of data for learning is input to the input layer of the neural network for processing (s1503). The discrimination results are output from the output layer after data processing by the neural network (s1504).

A ratio of discrimination results which correctly discriminated motions as a motion to be discriminated, among a plurality of discrimination results output from the neural network, is calculated (s1505). For example, if a motion to be discriminated is rising from a bed, when a number of data generated for a rising motion is N cases and a number of data generated for motions other than rising is M cases among the verifying data, N and M cases of data are input to the neural network. Here, let a number of outputs, obtained as a result of input of N cases of data generated for a rising motion and discriminated as rising (i.e., correct discriminations) be A, and a number of outputs discriminated as other than rising (i.e., incorrect discriminations) be B. Similarly, let a number of discrimination results, for M cases of data generated for motions other than rising and discriminated as rising (i.e., incorrect discriminations) be C, and a number of discrimination results discriminated as other than rising (i.e., correct discrimination) be D. Then, a ratio of results correctly discriminated as rising is A/N, and a ratio of results correctly discriminated as other than rising is D/M.

The above steps s1501 to 1505 are performed for each of neural networks while the parameters thereof are varied, and values of A/N and D/M for each of variations of the sensor conditions are compared (s1506), and the sensor conditions which achieved larger values of A/N and D/M are adopted as the sensor conditions of the optimized motion discrimination model 135 (s1507). In this case, when 2 sensor conditions, for example, P and Q are compared as a determining standard to adopt parameters, if P is larger for both of A/N and D/M, it may be configured to adopt the parameter condition P. In another case, if the parameter condition P is larger for A/N but the parameter condition Q is larger for D/M, it may be configured to adopt P or Q based on a ratio, i.e. (A+D)/(N+M), of cases correctly discriminated as a whole.

### 5. Making Motion Discrimination Highly Accurate Using Comparison of Sensor Output and Threshold Value

In an embodiment of the present invention, the threshold value determining means 137 of the analyzing/controlling part 130 compares degree of voltage values output from each of the passive sensors 410 to 430 of the motion discrimination system 190 with a predetermined threshold value to configure that a motion discrimination is not performed when the voltage value is smaller than the threshold value for improving accuracy of motion discrimination. When a motion of a patient etc. on a bed 301 is detected by the sensor module part 110 of the motion discrimination system 190, a voltage value corresponding to a type of motion is output from the sensor module part 110. In an embodiment of the present invention, since 3 passive sensors 410 to 430 are provided in the sensor module part 110, voltage values of the 3 channels are output from the sensor module part 110. The voltage values are also output other than when a motion to be discriminated is performed, thus, if voltage values reflecting motions other than the motion to be discriminated increase, subtle voltage waveform unique to the motion to be discriminated becomes undistinguishable among unnecessary voltage waveforms, which affects adversely to discrimination accuracy. To address the above, in an embodiment of the present invention, it may be configured as that a threshold value is predetermined for a voltage value such that a motion to be discriminated is correctly discriminated, and the motion discrimination model 135 performs motion discrimination only when a voltage value output from the sensor module part 110 exceeds the threshold value.

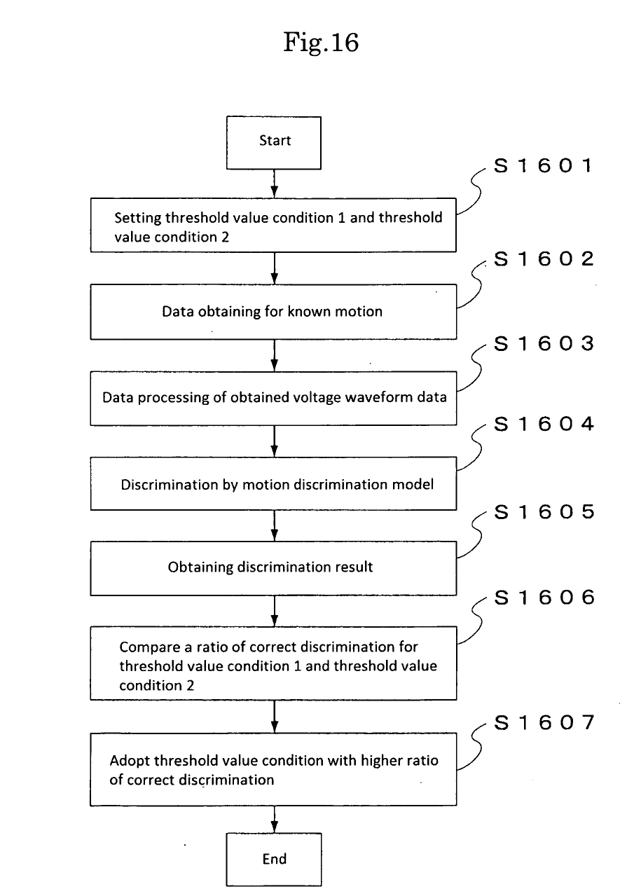

FIG. 16 is a flowchart illustrating a process for determining threshold conditions for the threshold value determining means 137. Two threshold values for comparison are firstly set as operating conditions of the motion discrimination model 135. The threshold values may be appropriately determined by a human in advance by checking voltage values output from the sensor module part 110 corresponding to motions. The motion discrimination model 135 is set, using the threshold value determining means 137 provided in the analyzing/controlling part 130, to operate when the voltage value output from the sensor module part 110 is larger than the threshold value and not to operate when the voltage value is smaller than the threshold value. The threshold values may be different for each of the channels or same for all the channels.

Then, a known motion performed by a test subject simulating a motion of a patient etc. to be discriminated is detected by the sensor module part 110 of the motion discrimination system 190 arranged as shown in FIG. 3, and a voltage waveform corresponding to the known motion is output (s1602). The output voltage waveform data are processed to become quantized time-series data through a similar processing as the aforementioned processing (FIG. 10) by the analog/digital converting part 120 (s1603). The processed data are input to the motion discrimination model 135 for data processing (s1604). The discrimination results are output from the motion discrimination model 135 in response to the input of the time-series data (s1605).

Next, a ratio of results correctly discriminated motions as a motion to be discriminated among a plurality of discrimination results output from the neural network for optimizing sensors is calculated for each of the threshold conditions for comparison (s1606). For example, if a motion to be discriminated is rising from a bed, when a number of data generated with rising motion is N cases and a number of data generated with motion other than rising is M cases among the verifying data, N and M cases of data are input to the neural network for optimizing sensors. Here, let a number of outputs, obtained as a result of input of N cases of data generated with rising motions and discriminated as rising (i.e., correct discriminations) be A, and a number of outputs discriminated as other than rising (i.e., incorrect discriminations) be B. Similarly, let a number of discrimination results, for M cases of data generated with motions other than rising and discriminated as rising (i.e., incorrect discriminations) be C, and a number of discrimination results discriminated as other than rising (i.e., correct discrimination) be D. Then, a ratio of results correctly discriminated as rising is A/N, and a ratio of results correctly discriminated as other than rising is D/M.

Values of A/N and D/M for each of the 2 threshold values are compared (s1606), and the one which achieved larger values of A/N and D/M are adopted as the threshold value (s1607). In this case, when 2 threshold values, for example P and Q, are compared as a determining standard to adopt a threshold value, if P is larger for A/N but Q is larger for D/M, it may be configured to adopt P or Q based on a ratio, i.e. (A+D)/(N+M), of cases correctly discriminated as a whole. The threshold value determining means 137 of the analyzing/controlling part 130 compares the threshold value as such determined and voltage value output from the sensor module part 110 to instruct the motion discrimination model 135 to perform motion discrimination when the voltage value is larger than the threshold value and not to perform motion discrimination when the voltage value is smaller than the threshold value.

1. A motion discrimination system optimized for real-time discrimination of a motion of an object, the system comprising:
a detecting means for outputting different analog values corresponding to a motion of an object in each of a plurality of detecting areas;
a data processing means for processing the analog values output corresponding to the motion in each of the plurality of detecting areas to quantized time-series data; and
a motion discrimination means for discriminating the motion using a motion discrimination model in which the time-series data are inputs and a type of motion is output and outputting a motion discrimination result.

2. The motion discrimination system according to claim 1, wherein the motion discrimination model is a neural network in which the time-series data are inputs to input nodes and the type of motion is output from output node.

3. The motion discrimination system according to claim 2, wherein the motion discrimination model is optimized by performing steps of:
obtaining analog values corresponding a known motion of an object using the detecting means;
processing the analog values output corresponding to the known motion in each of the plurality of detecting areas to quantized time-series data;
outputting a motion discrimination result by inputting the time-series data to the input nodes and outputting the type of motion from the output node of the neural network; and
adjusting parameters of the neural network based on a comparison of the motion discrimination result with the known motion.

4. The motion discrimination system according to claim 1, wherein the detecting means comprises passive sensors with a plurality of detecting elements and a plurality of lenses.

5. The motion discrimination system according to claim 4, wherein the plurality of detecting elements are any of dual-elements or quad-elements or a combination thereof.

6. The motion discrimination system according to claim 4, wherein the detecting means is optimized by performing steps of:
obtaining analog values corresponding to a known motion of an object using the detecting means;
processing the analog values output corresponding to the known motion in each of the plurality of detecting areas to quantized time-series data;
discriminating the known motion using a neural network in which the time-series data are inputs to the input nodes and the type of motion is output from the output node and outputting a motion discrimination result corresponding to the known motion; and
altering conditions of the detecting means based on the motion discrimination result.

7. The motion discrimination system according to claim 6, wherein the conditions of the detecting means may be one or a combination of a plurality of type, a number, position, sensitivity and rotating angle of the plurality of detecting elements, types and rotating angle of a plurality of lenses mounted on each of the plurality of detecting elements, and a mounting angle of the detecting means.

8. The motion discrimination system according to claim 1, wherein the motion discrimination means further comprises a time-series analysis model, said time-series analysis model discriminates the motion based on a time-series relationship of a plurality of discrimination results discriminated by the motion discrimination model and outputs the result of the discrimination.

9. The motion discrimination system according to claim 8, wherein the time-series relationship of the plurality of discrimination results is a ratio of a number of discrimination results discriminated as a certain motion to a number of other discrimination results discriminated as the other motion, and a consecutive number of the discrimination results discriminated as a certain motion, the ratio and the consecutive number being calculated for a predetermined number of a plurality of sequentially output discrimination results.

10. The motion discrimination system according to claim 1, wherein the system further comprises a communicating means for transmitting the discrimination result output by the motion discrimination means to one or more mobile information terminals or a device for notifying one or more mobile information terminals.

11. The motion discrimination system according to claim 1, wherein the system further comprises a determining means for comparing the analog values output from the detecting means and a predetermined threshold value, such that motion discrimination is not performed when the analog values are smaller than the predetermined threshold value.

12. The motion discrimination system according to claim 1, wherein the object is a cared person, a patient or an elderly person, and the motion of the object is either of rising, falling or leaving from a bed and others thereof.

13. A method for structuring a motion discrimination model optimized for discriminating motion in a motion discrimination system which discriminates a motion of an object in real-time, the method comprising:
a detecting step to obtain analog values corresponding to a known motion of an object using a detecting means for outputting different analog values corresponding to a motion of an object in each of a plurality of detecting areas;
a data processing step to process the analog values output corresponding to the known motion in each of the plurality of detecting areas to quantized time-series data;
a motion discriminating step to discriminate the known motion using a neural network in which the time-series data are inputs to the input nodes and the type of motion is output from the output node and output motion discrimination result corresponding to the known motion; and
a optimizing step to adjust parameters of the neural network based on a comparison between the motion discrimination result and the known motion.

14. The method for structuring a motion discrimination model according to claim 13, wherein the detecting means comprises passive sensors with a plurality of detecting elements and a plurality of lenses.

15. The method for structuring a motion discrimination model according to claim 14, wherein the plurality of detecting elements are any of dual-elements or quad-elements or a combination thereof.

16. A method for motion discrimination optimized for discriminating motion of an object in real-time, said method comprising:
a detecting step to obtain analog values corresponding to a motion of an object using a detecting means for outputting different analog values corresponding to a motion of an object in each of a plurality of detecting areas;
a data processing step to process the analog values output corresponding to the motion in each of the plurality of detecting areas to quantized time-series data; and
a motion discriminating step to discriminate the motion using the motion discrimination model in which the time-series data are inputs and a type of motion is output and output a motion discrimination result.

17. The method for motion discrimination according to claim 16, wherein the motion discrimination model is a neural network in which the time-series data are inputs to input nodes and the type of motion is output from output node.

18. The method for motion discrimination according to claim 17, wherein the motion discrimination model is optimized by performing steps of:
obtaining analog values corresponding a known motion of an object using the detecting means;
processing the analog values output corresponding to the known motion in each of the plurality of detecting areas to quantized time-series data;
outputting a motion discrimination result by inputting the time-series data to the input nodes and outputting the type of motion from output node of the neural network; and
adjusting parameters of the neural network based on a comparison of the motion discrimination result and the known motion.

19. The method for motion discrimination according to claim 16, wherein the detecting means comprises passive sensors with a plurality of detecting elements and a plurality of lenses.

20. The method for motion discrimination according to claim 19, wherein the plurality of detecting elements are any of dual-elements or quad-elements or a combination thereof.

21. The method for motion discrimination according to claim 19, wherein the detecting means is optimized by performing steps of:
obtaining analog values corresponding to a known motion of an object using the detecting-means;
processing the analog values output corresponding to the known motion in each of the plurality of detecting areas to quantized time-series data;
discriminating the known motion using a neural network in which the time-series data are inputs to the input nodes and the type of motion is output from the output node and outputting a motion discrimination result corresponding to the known motion; and
altering conditions of the detecting means based on the motion discrimination result.

22. The method for motion discrimination according to claim 21, wherein the conditions of the detecting means may be one or a combination of a plurality of type, a number, position, sensitivity and rotating angle of the plurality of detecting elements, types and rotating angle of a plurality of lenses mounted on each of the plurality of detecting elements, and a mounting angle of the detecting means.

23. The method for motion discrimination according to claim 16, wherein the motion discriminating step further comprises a step of discriminating the motion based on a time-series relationship of a plurality of discrimination results discriminated by the motion discrimination model and outputting the result of the discrimination.

24. The method for motion discrimination according to claim 23, wherein the time-series relationship of the plurality of discrimination results is a ratio of a number of discrimination results discriminated as a certain motion to a number of other discrimination results discriminated as the other motion, and a consecutive number of the discrimination results discriminated as a certain motion, the ratio and the consecutive number being calculated for a predetermined number of the plurality of sequentially output discrimination results.

25. The method for motion discrimination according to claim 16, wherein said method further comprises a communicating step for transmitting the discrimination result output through the motion discriminating step to one or more mobile information terminals or a device for notifying one or more mobile information terminals.

26. The method for motion discrimination according to claim 16, wherein the method further comprises a determining step for comparing the analog values output from the detecting means and a predetermined threshold value, such that motion discrimination is not performed when the analog values are smaller than the predetermined threshold value.

27. The method for motion discrimination according to claim 16, wherein the object is a cared person, a patient or an elderly person, and the motion of the object is either of rising, falling or leaving from a bed and others thereof.

28. A computer program comprising program code instructions for having a computer execute steps of the method according to any one of claim 16 to claim 27.
